(19) United States
(12) Patent Application Publication
(10) Pub. No.: US 2005/0063398 A1
(43) Pub. Date: Mar. 24, 2005

(54) Method of implementing L3 switching, network address port translation, and ALG support using a combination of hardware and firmware

(76) Inventors: Abhijit K. Choudhury, Cupertino, CA (US); Mathew Kayalackakom, Cupertino, CA (US); Shekhar Ambe, San Jose, CA (US); Ken C.K. Chin, Saratoga, CA (US)

Correspondence Address: Pillsbury Winthrop LLP;Intellectual Property Group, Suite 200, 11682 El Camino Real, San Diego, CA, 92130-2092, US

(21) Appl. No.: 10/883,978

(22) Filed: Jul. 2, 2004

Related U.S. Application Data
(60) Provisional application No. 60/484,811, filed on Jul. 3, 2003.

(51) Int. Cl. H04L 12/28

(52) U.S. Cl. 370/401

(57) ABSTRACT

An apparatus provides a hardware-based solution to enable support for L3 switching, network address port translation and application level gateways. The architecture involved in this hardware approach is such that it is scalable for implementation in a variety networking products that fulfill enterprise security and all possible combinations of wired and wireless networking needs, such as access points, access point concentrators, wireless-ready wiring closet or edge switches, and wireless co-processors.

### CROSS-REFERENCE TO RELATED APPLICATIONS

The present application claims priority to provisional application 60/484,811, filed on Jul. 3, 2003.

### FIELD OF THE INVENTION

Aspects of the present invention relate generally to network communications, and more particularly, to wired and wireless networks and architectures.

### BACKGROUND

The Wireless Local Area Network (WLAN) market has recently experienced rapid growth, primarily driven by consumer demand for home networking. The next phase of the growth will likely come from the commercial segment, such as enterprises, service provider networks in public places (Hotspots), multi-tenant, multi-dwelling units (MxUs) and small office home office (SOHOs). The worldwide market for the commercial segment is expected to grow from 5M units in 2001 to over 33M units in 2006. However, this growth can be realized only if the issues of security, service quality and user experience are addressed effectively in newer products.

FIG. 1 illustrates possible wireless network topologies. As shown in FIG. 1, a wireless network 100 typically includes at least one access point 102, to which wireless-capable devices such as desktop computers, laptop computers, PDAs, cellphones, etc. can connect via wireless protocols such as 802.11a/b/g. Several or more access points 102 can be further connected to an access point controller 104. Switch 106 can be connected to multiple access points 102, access point controllers 104, or other wired and/or wireless network elements such as switches, bridges, computers, and servers. Switch 106 can further provide an uplink to another network. Many possible alternative topologies are possible, and this figure is intended to illuminate, rather than limit, the present inventions.

One important issue with respect to wireless networking is the problem of Roaming and Session Persistence. Roaming allows the user to move from one network to another. (across same networks or across subnets) The user may do this intentionally to utilize a better or faster connection through a different Access Point or because user location has changed. Assuming that the user is originally authenticated while roaming user authentication across a WLAN should be transparent. The user should not require any manual action or any special application. There should be no reconfiguration needed when the user changes from one subnet to another. Any reconfiguration necessary should be done automatically. When roaming across subnets the WLAN user will encounter a problem with DHCP. As client changes network the new DHCP-server will provide a new IP-address. This will result in a break in an ongoing connection/session.

“Session persistence” means more than forwarding packets to a user's new location. “Persistence” can refer to just the problem of having packets forwarded as users roam among subnets, coverage areas and network types (wired LANs, wireless LANs and wireless WANs). More generally, it should refer to transport and application session persistence because when a transport protocol cannot communicate to its peer, the underlying protocols, like TCP, assume that the disruption of service is due to network congestion. When this occurs these protocols back off, reducing performance and eventually terminating the connection. WLAN networks have coverage holes causing dropouts even with access point overlap. This impacts a mobile device's range of mobility.

Meanwhile, many WLAN vendors are integrating combined 802.11a/g/b standards into their chipsets. Such chipsets are targeted for what are called Combo-Access Points which will allow users associated with the Access Points to share 100 Mbits of bandwidth in Normal Mode and up to ˜300 Mbits in Turbo Mode. The table below shows why a software roaming solution without hardware acceleration is not feasible when bandwidth/speeds exceed 100 Mbits.

| | | |
|---|---|---|
| | Required | |
| | Processor Speed | |
| Interface | [MHz] | CPU |

| | BW | | IPSec + | Subsys |
|---|---|---|---|---|
| Type | [Mbs] | IPSec | Other | Cost |
| DSL | 1-5 | 133 | 200+ | |
| Ether | 10 | 300 | 500+ | |
| 802.11a | 30-50 | 1200 | 1500+ | $400 |
| | | | | [2002] |
| | | | | $125 |
| | | | | [2004] |
| Fast | 100 | 2500 | 3000+ | $600 |
| Ether | | | | [2002] |
| | | | | $250 |
| | | | | [2004] |

| | | |
|---|---|---|
| Multiple | 500 | Not Feasible in Software |
| FE | | Needs Dedicated Hardware |
| Gigabit | 1000 | |
| Ether | | |

Although infrastructures for wired networks have been highly developed, the above and other problems of wireless networks are comparatively less addressed. Meanwhile, there is a need to address situations where enterprises and/or networks may have any combination of both wired and wireless components.

Further, another important feature for network devices that is not implemented in hardware, thus adversely affecting both wired and wireless network throughput, is support for L3 switching, network address port translation (NAPT) and application level gateways (ALGs).

### SUMMARY

Aspects of the present invention relate generally to a single-chip solution that addresses current weaknesses in wireless networks, but yet is scalable for a multitude of possible wired and/or wireless implementations. Current solutions to resolve/overcome the weaknesses of WLAN are only available in the form of Software or System. These resolve only specific WLAN problems and they don't address all of the existing limitations of wireless networks.

In accordance with an aspect of the invention, an apparatus provides a hardware-based solution to enable support for L3 switching, network address port translation and application level gateways. The architecture involved in this hardware approach is such that it is scalable for implementation in a variety networking products that fulfill enterprise security and all possible combinations of wired and wireless networking needs, such as access points, access point concentrators, wireless-ready wiring closet or edge switches, and wireless co-processors.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates wireless network topologies;

FIG. 2 is a block diagram illustrating a wired and wireless network device architecture in accordance with an embodiment of the present invention; and

FIG. 3 is a block diagram illustrating operation of a NAPT protocol embodiment.

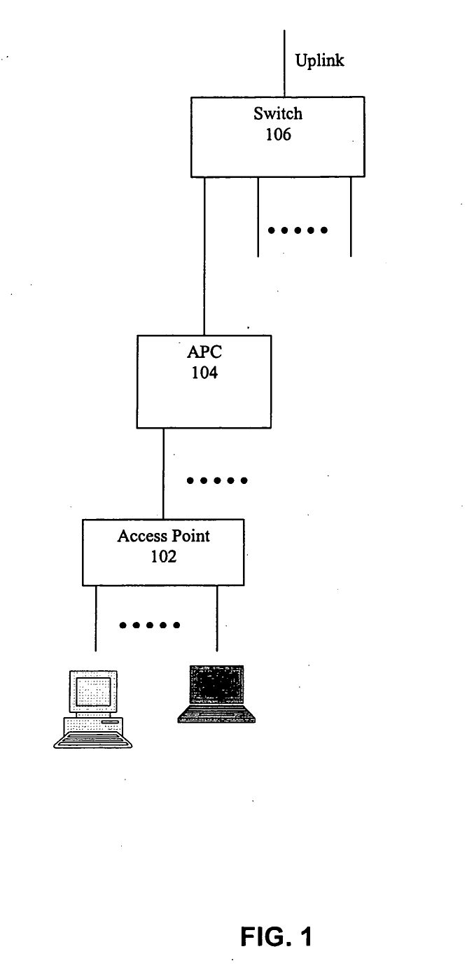

### DETAILED DESCRIPTION

One aspect of the present invention is the discovery that a hardware network device and solution may address wired and wireless network performance, including support for L3 switching, NAPT and ALGs. Such a device and solution may also be scalable to enable implementation in the various components and alternative topologies of wired and/or wireless networks, such as, for example, in an access point, an access point controller, or in a switch.

The embodiments of the present invention will now be described in detail with reference to the drawings, which are provided as illustrative examples of the invention so as to enable those skilled in the art to practice various embodiments of the invention. Notably, the figures and examples below are not meant to limit the scope of the present invention. Moreover, where certain elements of the embodiments can be partially or fully implemented using known components, only those portions of such known components that are necessary for an understanding of the embodiment will be described, and detailed descriptions of other portions of such known components will be omitted so as not to obscure the invention. Still further, the present invention encompasses present and future known equivalents to the known components referred to herein by way of illustration, and implementations including such equivalents are to be considered alternative embodiments of the invention.

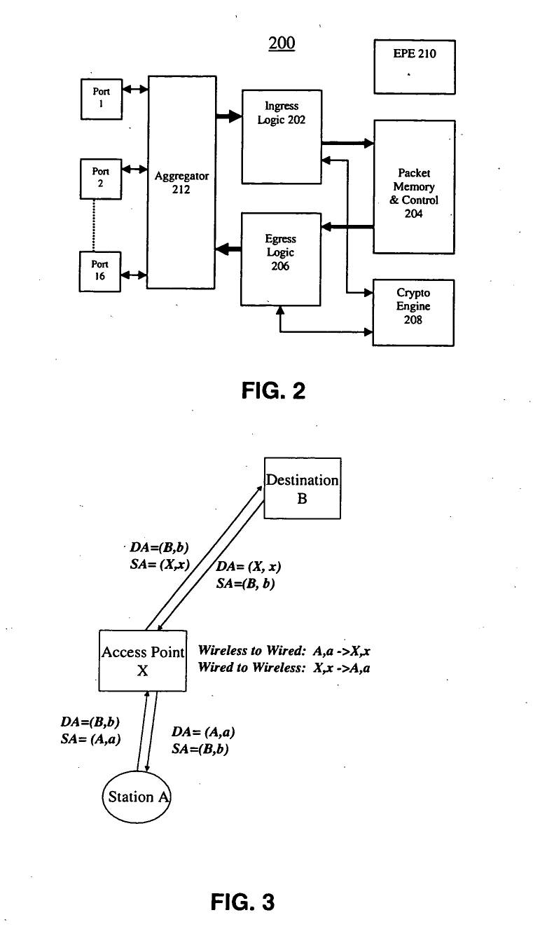

FIG. 2 is a block diagram illustrating an example of a single-chip wired and wireless network device 200 that can implement integrated hardware support for L3 switching, network address port translation, and application level gateways according to the present invention. As shown in FIG. 2, chip 200 includes ingress logic 202, packet memory and control 204, egress logic 206, crypto engine 208, an embedded processor engine 210 and an aggregator 212. Co-pending application No. ______ (Atty. Dkt. 79202-309844; SNT-001) describes the device 200 in more detail and its contents are incorporated herein by reference.

In one example implementation of the present invention, L3 switching, network address port translation, and application level gateways are supported by hardware in the ingress and egress paths 202 and 206, as well as by firmware running on the embedded processor engine 210.

As is known, Network Address Translation (NAT) is a method by which IP Addresses are mapped from one addressing realm to another, providing transparent routing to end hosts. Traditionally, NAT is used to connect an isolated addressing realm with private unregistered addresses to an external addressing realm with globally registered addresses. Network Address Port Translation (NAPT) extends the notion of translation one step further by also translating the transport identifiers (e.g., TCP/UDP port numbers, ICMP query identifiers). This allows the transport identifiers of multiple private hosts to be multiplexed onto the transport identifiers of a single external address. NAPT allows a set of hosts to share a single IP address or a small number of IP addresses. For packets outbound from the private network, NAPT would translate the source IP address, source transport identifier like the TCP/UDP port or ICMP query identifier, and related fields like the IP header checksum and the TCP/UDP/ICMP header checksum. For inbound packets, the destination IP address, destination transport identifier and the IP and transport header checksums would be modified.

FIG. 3 illustrates mapping of IP address and port using the NAPT functionality between the wireless station A and the destination B. DA and SA stand for Destination Address-Port pair and Source Address-Port pair respectively. The tuple (A,a) denotes (IP Address=A, Port=a). As shown in FIG. 3, a wireless station A, that is associated with an AP labeled X, communicating with a destination B over a TCP or UDP connection. Let DA denote the (Destination IP Address, Destination Port) tuple while SA will denote the (Source IP Address, Source Port) tuple. When station A, with IP Address A, sets up a connection between its own Port a and Port b on destination B with an IP Address B, the outbound session from station A, as shown in the figure, uses DA=(B,b) and SA=(A,a). The NAPT function on the AP alters the SA used to (X,x). The destination B is only aware of a connection with DA=(B,b) and SA=(X,x) and so it sets up a return connection with DA=(X,x) and SA=(B,b). The NAPT function on the AP uses the reverse mapping to remap this connection to one with DA=(A,a) and SA=(B,b), there by enabling a bi-directional connection to be set up. This bi-directional address binding is stored in the AP and used to translate packets between station A and destination B. The AP alters the SA on every packet from the station A to destination B using the (A,a)->(X,x) mapping while in the reverse direction it uses the (X,x)->(A,a) mapping to alter the DA on the packets going from the server B to station A. Note that packets exchanged between two wireless stations do not need NAPT support, and the same holds for packets exchanged between two hosts on the wired domain.

According to the present invention, integrated L3 switching, NAPT and ALG functionality on the device 200 is supported using a unified NAT/Encapsulation Table. One entry is created per direction per connection. In one example, the Table in device 200 will have (2K*2)=4K entries, thereby supporting 2K connections.

| | | | Size | Default |
|---|---|---|---|---|
| Field | Description | Name | (bits) | Value |
| Destination | Index to the location in the ARP Table of the | Dst_IP_Index | 13 | 0 |
| IP Index | Destination IP address in the Header | | | |
| Source IP | Index to the location in the ARP Table of the | Src_IP_Index | 13 | 0 |
| Index | Source IP address in the Header | | | |
| Destination | Destination port in the TCP/UDP Header | Dest_Port | 16 | 0 |
| Port | | | | |
| Source Port | Source port in the TCP/UDP Header | Src_Port | 16 | 0 |
| Protocol | Indicates the Transport Protocol for the | Protocol | 1 | 0 |
| | entry. Logic 0 indicates UDP while logic 1 | | | |
| | indicates TCP. | | | |
| New IP | Index to the location in the ARP Table of the | New_IP_Index | 13 | 0 |
| Index | IP Address for NAT or Tunnel | | | |
| New Port | Port for NAT or Tunnel | New_Port | 16 | 0 |
| Operation | Logic 0 indicates swapping fields while logic | Op | 1 | 0 |
| | 1 indicates encapsulation. | | | |
| EpeSelect | This bit is set to logic 1 if the packet needs to | EpeSelect | 1 | 0 |
| | be sent to the Embedded Processing Engine | | | |
| | (EPE). | | | |
| EpeNum | Logic 0 indicates EPE0 and logic 1 indicates | EpeNum | 1 | 0 |
| | EPE 1. | | | |
| Age | This field is used to indicate validity and also | Age | 2 | 0 |
| | age. 0x3 indicates invalid while the other | | | |
| | values indicate age. | | | |

The Host CPU sets up the entries in the NAT/Encapsulation Table. Setting the Age field to logic 0×3 indicates an invalid entry; other values are used to indicate various levels of age. For the NAPT functionality, the Operation field should have the value 0. A hash-based lookup of this table is uses a key comprising (Dest_IP_Index, Src_IP_Index, Dest_Port, Src_Port, Protocol) and returns (New_IP_Index, New_Port, Operation, EpeSelect, EpeNum). Every time an entry is accessed in the table the Age field is reset. A timer is used to periodically increase the age of the entry.

For a TCP connection, the first packet with the SYN bit set indicates the start of a connection, while a packet with the FIN bit or RST set indicates the end of a connection. If a packet arrives with a SYN bit set (for TCP) or if a lookup fails (for TCP or UDP), the packet is sent to the Host CPU, which then proceeds to set up an entry indicating the address binding for the connection in the NAT/Encapsulation Table. If a TCP packet arrives with the FIN bit or RST bit set, the corresponding entry is deleted from the table. Note that the Host CPU must wait for TCP_TIME_WAIT period of 4 min before assigning the same address binding to another connection. Alternatively, if a new connection is needed and the NAT/Encapsulation Table is full, an LRU policy is used to replace the existing connections.

The NAT/Encapsulation Table lookup is preceded by two lookups of the ARP table—one based on the Source IP Address and one based on the Destination IP Address. These are primarily to obtain the indices corresponding to the locations of the Source IP Address and the Destination IP Address in the ARP Table. The NAT Table stores these indices instead of the actual 32-bit addresses to reduce the size of the table. The NAT Table lookup returns a New_IP_Index and a New_Port. However, in the “Wireless-to-Wired” direction, the New_IP_Index and New_Port values are not used to replace the (Src_IP, Src_Port) pair in the packet header immediately. This is because the inbound ACL processing is done using the original (Src_IP, Src_Port) value. In the “Wired-to-Wireless” direction, the New_IP_Index and New_Port values are used to replace the (Dst_IP, Dst_Port) pair right away and the new Destination IP Address is used to perform the lookup in the ARP Table as well as the inbound ACL processing. The IP Header and TCP/UDP Header Checksums need to be updated following the change.

Some packets need to be sent to the Embedded Processor Engine (EPE) where all the ALGs are to be executed. After the ALGs have been used to update the packet fields, the packet is reintroduced into the packet pipeline. Note that not all packets need to be sent to the EPE. For example, in an FTP session, only the packets from the FTP Control session are sent to the EPE. The FTP ALG running on the EPE maintains a table for where it stores the (Delta_Seq, Delta_Ack) for each direction of each FTP connection. (Delta_Seq, Delta_Ack) are the differences from the original sequence and acknowledgement numbers respectively caused by the modifications to the IP Address and Port carried in the payload of the PORT command and PASV response. Every PORT command and PASV response results in an update to the (Delta_Seq, Delta_Ack) values. Every subsequent control packet, that is not PORT or PASV, has its sequence number and acknowledgement number updated using the (Delta_Seq, Delta_Ack) values.

The Known Ports Table is used to check if the Source or Destination TCP/UDP ports correspond to ports that require ALG processing. The Known Ports Table has a list of well known ports that are used to set up connections for various applications like FTP, SIP, H.323 etc. In some applications, the later stages of the connection set up usually involve negotiation of ephemeral ports. To trap packets headed to these ports and send them to the EPE, the EPE makes the appropriate entry in the NAT/Encapsulation Table and also sets the NatEn bit for the corresponding IP Address in the ARP Table. Any Wireless-to-Wired packet always performed a NAT/Encapsulation Table lookup. All other packets perform the lookup only if the entry corresponding to the Destination IP Address in the ARP Table has the NatEn bit set.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims include such changes and modifications.

1. An apparatus for application in a wired and/or wireless network comprising:
a scalable ingress path;
a scalable egress path;
an aggregator configured to receive packets from ports, configured to provide a stream for the ingress path, configured to receive a stream from the egress path, and configured to output packet data to the ports;
a switching table configured to support network address translation.

2. The apparatus of claim 1, the switching table is further configured to support packet encapsulation.

3. The apparatus of claim 2 the switching table further configured to support one entry per packet direction.

4. The apparatus of claim 3, wherein the switching table is indexed corresponding to locations of a source address and a destination address.

5. The apparatus of claim 4, wherein the scalable ingress path is further configured to determine whether the stream for the ingress path has to undergo authentication.

6. The apparatus of claim 4, further comprises:
a packet memory configured to store data from the stream for the ingress path and to the data stream for the egress path.

7. The apparatus of claim 6, further comprises:
a packet memory scheduler configured to schedule the data from the packet memory to the data stream for the egress path.

8. The apparatus of claim 7, wherein the scalable egress path is further configured to determine whether the stream for the egress path has to undergo encryption.

9. The apparatus of claim 8, wherein the scalable egress path is further configured to request that the encryptor block encrypt the stream for the egress path.

10. The apparatus of claim 9, wherein the decryptor block or the encryptor block supports IPSec, L2TP with IPSec, PPTP, or SSL Encryption algorithms.

11. The apparatus of claim 10, wherein the decryptor block or the encryptor block supports IPSec, L2TP with IPSec, PPTP, or SSL authentication algorithms.

12. The apparatus of claim 9, wherein the egress path or the ingress path further comprises:
access control logic configured to forward packets based an entry in an access control list.

13. The apparatus of claim 12, wherein the access control logic is further configured to:
drop packets based the entry on the access control list.

14. The apparatus of claim 13, wherein the access control logic is further configured to:
redirect packets based the entry on the access control list.

15. The apparatus of claim 14, wherein the packet is redirected to a port.

16. The apparatus of claim 13, wherein the access control logic is further configured to:
modify packets based the entry on the access control list.

17. The apparatus of claim 16, wherein the access control logic modifies 802.11 p or DiffServ Code Point (DSCP) fields of the packet.

18. The apparatus of claim 13, wherein the access control logic is further configured to:
send the packet to a central processing unit (CPU) or Embedded Processing Engine (EPE) based the entry on the access control list.

19. The apparatus of claim 13, wherein the access control logic is further configured to:
update a counter based the entry on the access control list.

20. The apparatus of claim 13, wherein the access control logic is further configured to:
assign a queue identifier to the packet based the entry on the access control list.

21. An method of processing data packets in a wired and/or wireless network comprising:
receiving a packet stream from one or more ports;
providing the packet stream to a scalable ingress path;
storing the packet stream;
outputting the packet stream to the one or more ports via a scalable egress path;
supporting network address translation using a switching table.

22. The method of claim 21, the switching table is further configured to support packet encapsulation.

23. The method of claim 22 the switching table further configured to support one entry per packet direction.

24. The method of claim 23, wherein the switching table is indexed corresponding to locations of a source address and a destination address.

25. The method of claim 24 further comprising:
authenticating the packet stream received from one or more ports when the packet stream requires authentication.

26. The method of claim 25, further comprises:
scheduling the output of the packet stream to the one or more ports via a scalable egress path.

27. The method of claim 26, further comprises:
determining whether the packet stream in the scalable egress path has to undergo encryption.

28. The method of claim 27 further comprising:
encrypting the packet stream when the packet stream in the scalable egress path has to undergo encryption.

29. The method of claim 28, wherein the encryption encryption is as per 802.11i, IPSec, L2TP with IPSec, PPTP, or SSL algorithms.

30. The method of claim 29, wherein the authentication encryption is as per 802.11i, IPSec, L2TP with IPSec, PPTP, or SSL Authentication algorithm.

31. The method of claim 28, further comprising:
forwarding packets based an entry in an access control list.

32. The method of claim 31, further comprising:
dropping packets based the entry on the access control list.

33. The method of claim 32, further comprising:
redirecting packets based the entry on the access control list.

34. The method of claim 33, wherein the packet is redirected to a port.

35. The method of claim 32, further comprising:
modifying packets based the entry on the access control list.

36. The method of claim 35, wherein 802.11p or DiffServ Code Point (DSCP) fields of the packet are modified.

37. The method of claim 32, further comprising:
sending the packet to a central processing unit (CPU) or Embedded Processing Engine (EPE) based the entry on the access control list.

38. The method of claim 32 further comprising:
updating a counter based the entry on the access control list.

39. The method of claim 32 further comprising:
assigning a queue identifer to the packet based the entry on the access control list.

40. A computer-readable medium, encoded with data and instructions, such that when executed by a computer, the instructions causes the computer to:
receive a packet stream from one or more ports;
provide the packet stream to a scalable ingress path;
store the packet stream;
output the packet stream to the one or more ports via a scalable egress path;
support network address translation using a switching table.

41. The computer-readable medium of claim 40, the switching table is further configured to support packet encapsulation.

42. The computer-readable medium of claim 41 the switching table further configured to support one entry per packet direction.

43. The computer-readable medium of claim 42, wherein the switching table is indexed corresponding to locations of a source address and a destination address.

44. The computer-readable medium of claim 43 further comprising instructions to:
authenticate the packet stream received from one or more ports when the packet stream requires authentication.

45. The computer-readable medium of claim 44, further comprises instructions to:
schedue the output of the packet stream to the one or more ports via a scalable egress path.

46. The computer-readable medium of claim 45, further comprise instructions to s:
determine whether the packet stream in the scalable egress path has to undergo encryption.

47. The computer-readable medium of claim 46 further comprising instructions to:
encrypt the packet stream when the packet stream in the scalable egress path has to undergo encryption.

48. The computer-readable medium of claim 47, wherein the encryption is encryption is as per 802.11i, IPSec, L2TP with IPSec, PPTP, or SSL Encryption algorithms Encryption algorithm.

49. The computer-readable medium of claim 48, wherein the authentication encryption is as per 802.11i, IPSec, L2TP with IPSec, PPTP, or SSL Authentication algorithms.

50. The computer-readable medium of claim 47, further comprises instructions to:
forward packets based an entry in an access control list.

51. The computer-readable medium of claim 50, further comprises instructions to:
drop packets based the entry on the access control list.

52. The computer-readable medium of claim 51, further comprises instructions to:
redirect packets based the entry on the access control list.

53. The computer-readable medium of claim 52, wherein the packet is redirected to a port.

54. The computer-readable medium of claim 51, further comprises instructions to:
modify packets based the entry on the access control list.

55. The computer-readable medium of claim 54, wherein the access control logic modifies 802.11p or DiffServ Code Point (DSCP) fields of the packet.

56. The computer-readable medium of claim 51, further comprises instructions to:
send the packet to a central processing unit (CPU) or Embedded Processing Engine (EPE) based the entry on the access control list.

57. The computer-readable medium of claim 51, further comprises instructions to:
update a counter based the entry on the access control list.

58. The computer-readable medium of claim 51, further comprises instructions to:
assign a queue identifer to the packet based the entry on the access control list.

59. An apparatus of processing data packets in a wired and/or wireless network comprising:
means for receiving a packet stream from one or more ports;
means for providing the packet stream to a scalable ingress path;
means for storing the packet stream;
means for outputting the packet stream to the one or more ports via a scalable egress path;
a switching table configured to support network address translation.

60. The apparatus of claim 59, the switching table is further configured to support packet encapsulation.

61. The apparatus of claim 60 the switching table further configured to support one entry per packet direction.

62. The apparatus of claim 61, wherein the switching table is indexed corresponding to locations of a source address and a destination address.

63. The apparatus of claim 62 further comprising:
means for authenticating the packet stream received from one or more ports when the packet stream requires authentication.

64. The apparatus of claim 63, further comprises:
means for scheduling the output of the packet stream to the one or more ports via a scalable egress path.

65. The apparatus of claim 64, further comprises:
means for determining whether the packet stream in the scalable egress path has to undergo encryption.

66. The apparatus of claim 65 further comprising:
means for encrypting the packet stream when the packet stream in the scalable egress path has to undergo encryption.

67. The apparatus of claim 66, wherein the encryption encryption is as per 802.11i, IPSec, L2TP with IPSec, PPTP, or SSL Encryption algorithms Encryption algorithm.

68. The apparatus of claim 67, wherein the authentication encryption is as per 802.11i, IPSec, L2TP with IPSec, PPTP, or SSL Authentication algorithm.

69. The apparatus of claim 66, wherein the egress path further comprises:
means for forwarding packets based an entry in an access control list.

70. The apparatus of claim 69, further comprising:
means for dropping packets based the entry on the access control list.

71. The apparatus of claim 70, further comprising:
means for redirecting packets based the entry on the access control list.

72. The apparatus of claim 71, wherein the packet is redirected to a port.

73. The apparatus of claim 72, further comprising:
means for modifying packets based the entry on the access control list.

74. The apparatus of claim 73, wherein the access control logic modifies 802.11p or DiffServ Code Point (DSCP) fields of the packet.

75. The apparatus of claim 72, further comprising:
means for sending the packet to a central processing unit (CPU) or Embedded Processing Engine (EPE) based the entry on the access control list.

76. The apparatus of claim 72, further comprising:
means for updating a counter based the entry on the access control list.

77. The apparatus of claim 72, further comprising:
assign a queue identifer to the packet based the entry on the access control list.
